(19) United States
(12) Patent Application Publication
(10) Pub. No.: US 2026/0316866 A1
(43) Pub. Date: Oct. 15, 2026

(54) Device For Guiding At Least One Cable In A Frame Of A Bicycle

(71) Applicant: SCOTT Sports SA, Givisiez (CH)

(72) Inventor: Loris Tupin, Givisiez (CH)

(73) Assignee: SCOTT Sports SA, Givisiez (CH)

(21) Appl. No.: 19/640,907

(22) Filed: Apr. 7, 2026

(30) Foreign Application Priority Data
Apr. 9, 2025 (DE) 102025114062.6

(51) Int. Cl. B62J 11/10

(52) U.S. Cl. CPC B62J 11/10

(57) ABSTRACT

A device for guiding at least one cable in a frame of a bicycle includes an introduction device, which can be attached to a first tube of the frame, for introducing the at least one cable into the first frame tube and at least one hose for receiving the cable. The at least one hose is arranged with a first end on the introduction device and can be received in the first tube and at least one further frame tube.

### CROSS REFERENCE TO RELATED APPLICATIONS

The present application claims priority from German Application No. 102025114062.6 filed Apr. 9, 2025, the disclosure of which is hereby incorporated herein by reference.

### FIELD OF THE INVENTION

The invention relates to a device for guiding at least one cable in a frame of a bicycle and to a frame having such a device.

### BACKGROUND OF THE INVENTION

Cables (in particular mechanical lines, hydraulic lines or electrical cables) are guided more and more within the frame of bicycles, namely bicycles and e-bikes (internal cable guidance).

The internal cable guidance avoids damage to the cables due to dirt, water and mechanical external influences. It improves the aerodynamics of the bicycle and its aesthetic appearance. Carbon frames in particular also offer flexible design options for the integration of the cable guidance. Recent developments such as hydraulic braking systems and electrical shifting systems benefit in particular from the internal cable guidance.

The best possible integration of the cables is achieved if the cables are already introduced into the frame in the region of the fork and not only into the top and/or down tube.

However, challenges are also associated with the internal cable guidance:
The installation and maintenance of internally laid cables requires more time and special tools, since access is restricted.
Particularly in the case of hydraulic brakes, the venting or exchange can be more complicated.
The frame construction becomes more complicated, since special openings and channels for the lines have to be integrated. This can increase the manufacturing costs.
In the case of improper assembly, cables can rattle in the frame, which increases the development of noise during driving.

### BRIEF SUMMARY OF THE INVENTION

An aspect of the invention relates to a device belonging to the technical field mentioned at the outset for guiding at least one cable in a frame of a bicycle which avoids one, more or all of the abovementioned disadvantages.

According to an embodiment of the invention, the device comprises
a) an introduction device, which can be attached to a first tube of the frame, for introducing the at least one cable into the first tube and
b) at least one hose for receiving the cable.

The at least one hose is arranged with a first end on the introduction device and can be received in the first tube and at least one further frame tube.

The bicycle is in particular a bicycle or a bicycle with a supporting drive (e-bike, pedelec, etc.).

The introduction device serves to guide the at least one cable from an exterior space, for example in the handlebar region, into the frame of the bicycle. The hose arranged with its first end on the introduction device serves to guide the at least one cable further within the frame, for example from the head tube as first tube further into the down tube or from the head tube further into the top tube. The at least one hose correspondingly preferably has a length of at least 20 cm, in particular at least 50 cm. The cable can thus be guided within the hose in particular as far as the rear end region of the down tube or of the top tube, in particular as far as the region of the last quarter of the corresponding tube. The additional length which is required on account of handlebar movements is taken into account in the dimensioning of the hose length.

The hose is in particular a flexible hose. This simplifies the assembly and enables movements in order, for example, to follow movements of the handlebar. Alternatively, however, rigid or dimensionally stable hoses can also be used.

The device can comprise a plurality of hoses, wherein preferably each of the hoses receives in each case one cable. The device can be configured in such a way that the introduction device is set up for introducing a number of cables, up to a maximum number, and that a smaller number of cables can also be introduced into the frame with this introduction device. It is thus unnecessary to provide separate introduction devices for each desired number of cables.

The cables can be in particular mechanical lines, electrical lines or hydraulic lines.

The introduction device and the at least one hose arranged thereon ensure a defined cable guidance. On the one hand, they protect the cable from external influences, for example mechanical influences and moisture. In particular, buckling of cables is also prevented, in particular in the case of rapid and heavy handlebar movements. On the other hand, the inner side of the frame and other components, such as, for example, the fork shaft, are also protected from mechanical damage on account of rubbing or impacting cables, as can in turn occur in particular on account of steering movements. Previously used separate elements, for example plastic nets, for protecting the fork shaft are unnecessary. In addition, undesirable rattling noises are avoided.

The guidance of the cables in a hose, the position of which is fixed by the arrangement on the introduction device, makes it possible to push the cable guided in the hose from the rear end of the hose easily forward, in the direction of the introduction device, for example during assembly or for maintenance purposes.

Preferably, the first tube is a head tube of the bicycle and the introduction device comprises an annular element for arrangement in the head tube. In this case, the annular element has at least one opening for guiding the cable into the head tube, and a rigid guide part is arranged on the annular element. In this case, the first end of the hose is arranged on the inside of the head tube on the guide part in such a way that the cable can be guided through the opening into the hose.

By using an opening which is present in any case for introducing the cable, additional openings in the head tube which could weaken the structure of the latter and create potential sealing problems are unnecessary.

The rigid guide part prevents buckling of the cable in the region of the introduction, where the forces acting on the cable would otherwise be particularly high. The rigid guide part can also be designed in such a way that reliable sealing is achieved. Suitable material for the guide part is in particular a suitable plastic such as polyamide or PET. These materials are lightweight, robust and not susceptible to corrosion.

Preferably, the annular element is a clamping ring of a headset. By using an annular element which is present in any case, the outlay on components is minimized.

The cable is guided in particular between the clamping ring and the upper bearing of the headset. The clamping ring and therefore the guide part follow the movement of the handlebar. The cables guided in the hoses are then deformed primarily within the head tube on account of these rotational movements, wherein the type and the extent of the deformation on account of the defined guidance by the guide part and the support by the respective hose maintain limits which avoid short-term and long-term damage to the cable.

In alternative embodiments, the annular element can be received in a press fit in the head tube, that is to say is arranged in a rotationally fixed manner on the head tube. The fork shaft is then mounted within this annular element.

The annular element can be a one-piece component or is composed of a plurality of parts.

Preferably, the at least one opening on the clamping ring is formed by an arcuate recess on an outer edge of the annular element. This enables a simple but stable construction.

Preferably, the guide part is designed in such a way that, in the region of the first end, a centre axis of the hose runs at an angle to a central axis of symmetry of the annular element. As a result, the cable runs in a direction running obliquely rearward and downward from the exterior space into the further frame tube, and its bending is minimized. In addition, the cable can be guided around the fork shaft. The angle is in particular 20-60°, in particular 30-45°.

Preferably, the guide part can be removably fastened to the annular element, in particular by means of a screw connection and/or clip connection. Particularly preferred is a screw connection in which the screw head is received on the outside of the annular element, in a matching receptacle, and in which the thread interacts with a threaded receptacle on the guide part. As a result, the screw is easily accessible and can be released easily and rapidly if required. In particular, the screw connection comprises a plurality of screws arranged in this way.

The connection is additionally stabilized if the guide part has pin-like projections which interact with matching receptacles on the underside of the clamping ring. The threaded receptacles can be formed in these pin-like projections.

Alternatively, the guide part is configured in one piece with the annular element or a component of the annular element.

Preferably, at least two hoses can be fastened to the guide part. In this case, the at least two hoses can be guided, in particular, through the same opening of the annular element. This enables reliable guidance of a plurality of cables which can be introduced into the head tube through the same opening.

Preferably, at least two guide parts can be attached in a modular manner to the annular element. Each of the guide parts can therefore be exchanged individually for another guide part of the same or a different type. The guide parts which are available can be designed for fastening different numbers of hoses. Thus, for example, a guide part of a first type (type I) can be provided which has a single hose connection and a guide part of a second type (type II) with two hose connections. Of these guide parts, for example, two can then be fastened simultaneously to the annular element, one each on the left-hand handlebar side and one on the right-hand handlebar side. If no guide part is required in a receptacle of the annular element, it can be covered, for example, with a panel. The following configurations are therefore possible, depending on the number of cables to be guided and the direction from which the cables are guided to the upper end of the head tube:

| left-hand | right-hand | |
|---|---|---|
| receptacle | receptacle | cable |
| panel | type I | 1 from the right |
| panel | type II | 2 from the right |
| type I | panel | 1 from the left |
| type I | type I | 1 from the left, 1 from the right |
| type I | type II | 1 from the left, 2 from the right |
| type II | panel | 2 from the left |
| type II | type I | 2 from the left, 1 from the right |
| type II | type II | 2 from the left, 2 from the right |

In particular, two receptacles for two guide parts (or panels) are present, and the guide parts are provided in two symmetrical embodiments, so that cable guidance is enabled on both sides of the fork shaft.

In alternative embodiments, only one guide part can be fastened in a modular manner to the annular element. This can have a plurality of hose connections (for example 2, 3 or 4).

In a further group of embodiments, the introduction device comprises a holding element for arrangement in a lateral opening in the first tube, wherein the holding element has at least one opening for guiding the cable into the first tube, and wherein a rigid guide part is arranged on the holding element, wherein the first end of the hose is arranged on the inside of the first tube on the guide part in such a way that the cable can be guided through the opening into the hose.

Preferably, the guide part can be removably fastened to the holding element, in particular by means of a clip connection. This minimizes the outlay on components and allows simple assembly.

Preferably, at least two hoses can be fastened to the guide part. In this case, the at least two hoses can be guided, in particular, through the same opening of the holding element. This enables reliable guidance of a plurality of cables which can be introduced into the first tube through the same opening.

Preferably, in order to fasten the hose to the guide part, a hollow-cylindrical insert can be inserted into a region at the first end of the hose, after which the first end of the hose with inserted insert can be inserted into a hollow-cylindrical receptacle of the guide part, so that the hose is clamped in the receptacle. The hollow-cylindrical shape is in particular a circular-cylindrical shape, but polygonal, oval or contoured cross sections are also possible, for example.

The insert is manufactured in particular from a metallic material. It is dimensionally stable, so that pressing forces can be built up between the receptacle and the insert, said pressing forces securely holding the hose.

Preferably, the insert has, at one of its ends, a radially outwardly directed collar for support on the guide part. On the one hand, this prevents the insert from being pulled back through the receptacle of the guide part and thus prevents the hose from being unintentionally released from the guide part. On the other hand, the insert can be pulled out of the hose on the corresponding side with the aid of the collar, after which the hose can be removed from the receptacle in a simple manner. The collar can be of annular circumferential design, but it is also possible for it to surround the central opening of the insert only partially. In this case, it can be formed from one or more collar sections distributed over the circumference.

Preferably, the device further comprises a connecting part for arrangement in the further frame tube, wherein the at least one hose can be arranged with a second end on the connecting part. The hose therefore runs from the introduction device on the head tube through the head tube and the at least one further frame tube as far as the connecting part, and it is arranged with its first end on the introduction device and with its other end on the connecting part, in particular fixed in each case. This further simplifies the introduction and pushing back of the cable in the hose. In addition, a defined guidance of the cable from the entry into the head tube as far as the connecting part in the further frame tube results. Damage to elements of the frame or to elements which are arranged in the frame, and also noises, are avoided.

The connecting part can be designed for arrangement of a plurality of hoses. In particular, it comprises a plurality of hose receptacles arranged in parallel. In particular, these can be positioned next to one another in a row, resulting in a flat arrangement which can be positioned with little space requirement directly on the inner side of the respective frame tube. However, alternative geometries with different positions and/or orientations are also possible.

The hose is in turn preferably fastened to the connecting part with the aid of a hollow-cylindrical insert which can be inserted into a region at the first end of the hose, after which the second end of the hose with inserted insert can be inserted into a hollow-cylindrical receptacle of the connecting part, so that the hose is clamped in the receptacle. The hollow-cylindrical shape is in particular a circular-cylindrical shape, but oval or contoured cross sections are also possible, for example.

The insert is manufactured in particular from a metallic material. It is dimensionally stable, so that pressing forces can be built up between the receptacle and the insert, said pressing forces securely holding the hose.

Preferably, the insert has, at one of its ends, a radially outwardly directed collar for support on the connecting part. On the one hand, this prevents the insert from being pulled back through the receptacle of the connecting part and thus prevents the hose from being unintentionally released from the connecting part. On the other hand, the insert can be pulled out of the hose on the corresponding side with the aid of the collar, after which the hose can be removed from the receptacle in a simple manner. The collar can be of annular circumferential design, but it is also possible for it to surround the central opening of the insert only partially. In this case, it can be formed from one or more collar sections distributed over the circumference.

Preferably, the at least one hose is a glass-fibre hose with silicone sheathing. Such a hose is simultaneously flexible and wear-resistant. In addition, the silicone sheathing avoids damage to parts in the surroundings, for example frame tubes or the fork shaft.

The invention also comprises a frame for a bicycle having a device according to the invention for guiding cables.

If a connecting part for arrangement in the further frame tube is present, then, in a preferred embodiment, this is arranged at the lower end of the down tube, in the vicinity of the bottom bracket. In variants, such a connecting part can also be arranged at the rear end of the top tube, for example in cases where there is not sufficient space available for the cable guidance in the down tube, because, for example, a drive battery is accommodated in the down tube.

In this case, the connecting part is preferably moulded directly into the further frame tube. This solution can be implemented in particular in the case of carbon frames.

Alternatively, the connecting part is a separate component which is fastened, for example adhesively bonded, to the inner side of the frame tube. This component can consist, for example, of a carbon material, a suitable alloy or a suitable plastic. Fastening by means of a screw connection or a clip connection is also possible.

The connecting part can in principle be arranged in the frame tube on any suitable surface (bottom, top, right, left).

So that cables can be connected, released or pushed back in the region of the connecting part, the connecting part is preferably arranged in the region of a frame opening. The frame opening can be, for example, an access opening to a damper, to a receiving space or to a drive battery or else a dedicated frame opening for access to the connecting part.

Further advantageous embodiments and combinations of features of the invention emerge from the following detailed description and the entirety of the claims.

### BRIEF DESCRIPTION OF THE DRAWINGS

The drawings used to explain the exemplary embodiment show:

FIG. 1 an exploded view of a first embodiment of an introduction device according to the invention with hoses arranged thereon for receiving cables;

FIG. 2 an isometric view of a pair of guide parts;

FIG. 3 an isometric view of the guide parts with attached hoses;

FIG. 4 an isometric view of the introduction device arranged on a fork;

FIG. 5 a side view of the fork, the head tube and the introduction device;

FIG. 6 a plan view of the fork with the introduction device mounted;

FIG. 7A, B two vertical sections through the head tube with the introduction device mounted;

FIG. 7C a horizontal section through the head tube and the introduction device;

FIG. 8 an exploded illustration of a second embodiment of an introduction device according to the invention with hoses arranged thereon for receiving cables;

FIG. 9A an exploded view of a third embodiment of an introduction device according to the invention with hoses arranged thereon for receiving cables;

FIG. 9B a cross-sectional view of the introduction device according to the third embodiment received in a head tube;

FIG. 10 an exploded view of a connecting part according to the invention for arrangement in a down tube;

FIG. 11 a view of the connecting part arranged in the down tube; and

FIG. 12 a schematic view of the assembly of the device according to the invention in the frame of a bicycle.

In principle, identical parts are provided with identical reference numerals in the figures.

### DETAILED DESCRIPTION

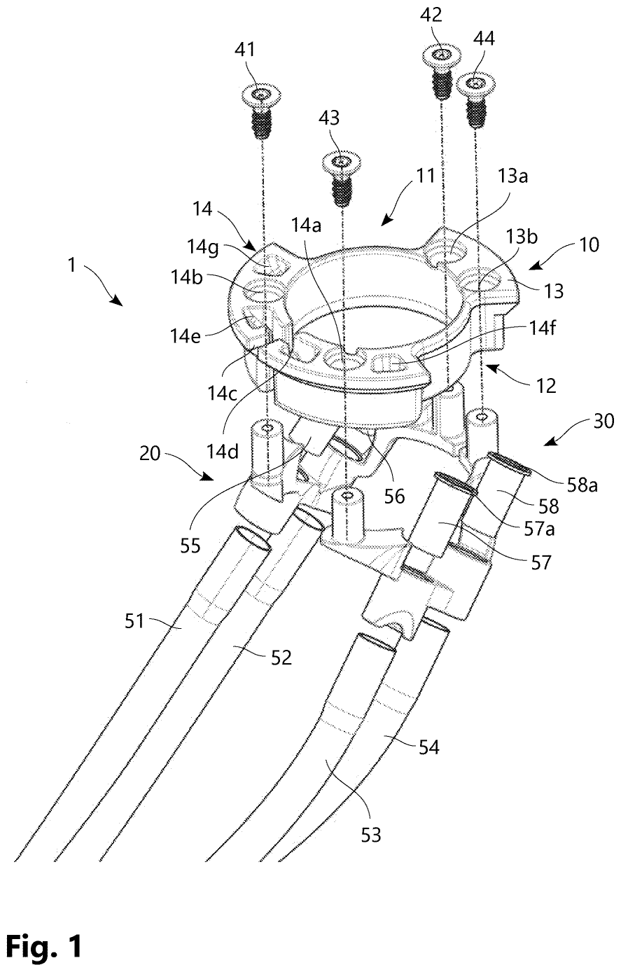

FIG. 1 is an exploded view of a first embodiment of an introduction device according to the invention with hoses arranged thereon for receiving cables. The introduction device 1 comprises a clamping ring 10 and two guide parts 20, 30 fastened thereto.

The clamping ring 10 has substantially the shape of a circular ring. Two sector-like recesses 11, 12 with an angle of in each case approximately 45° are present symmetrically along the circumference. Located between the recesses are, on the one hand, a first segment 13 which extends over an angle of approximately 30° and has two circular-cylindrical passage openings 13a, 13b, and, on the other hand, a second segment 14 which extends over an angle of approximately 160°. The second segment has, in its center, a radially continuous slot 14c. Substantially rectangular recesses 14d, 14e open laterally into the slot 14c on both sides. Two further circular-cylindrical passage openings 14a, 14b are present laterally with respect to these recesses. Two passage openings 14f, 14g with a trapezoidal base area are again located outside these passage openings 14a, 14b. The circular-cylindrical passage openings 13a, 13b, 14a, 14b open at the end side into a concentric section of larger diameter.

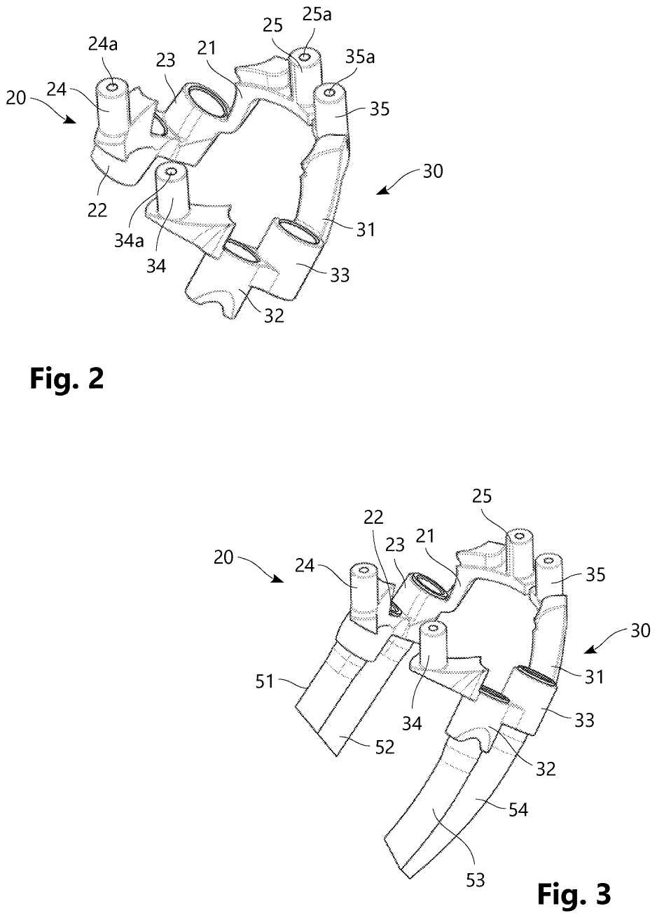

The two guide parts 20, 30 are manufactured from polyamide and are configured mirror-symmetrically with respect to one another. They are shown individually in FIG. 2. Each of the guide parts 20, 30 has an annular frame 21, 31. In each case two guide cylinders 22, 23; 32, 33 are formed in one piece on the latter. Likewise, fastening pins 24, 25; 34, 35 are formed in one piece in each case at the ends of the frames 21, 31. They have a cylindrical shape and have a central opening 24a, 25a; 34a, 35a with an internal thread. The central axes of the guide cylinders 22, 23 of the first guide part and the central axes of the guide cylinders 32, 33 of the second guide part are in each case parallel to one another. In addition, they have an angle of approximately 35° with respect to the central axes of the central openings 24a, 25a; 34a, 35a in the fastening pins 24, 25; 34, 35, which are all parallel to each other.

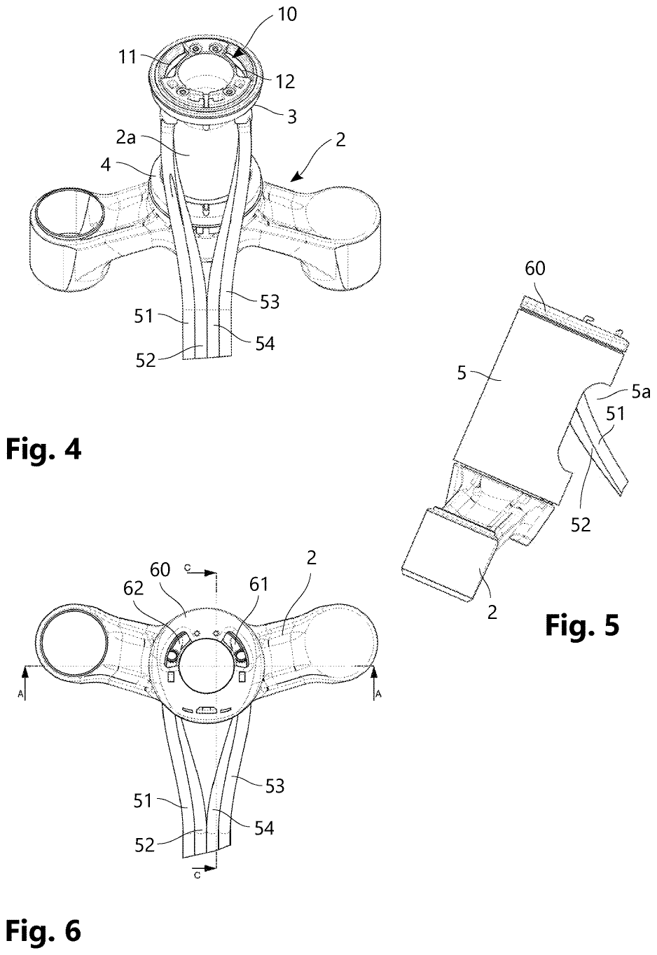

The guide parts 20, 30 are screwed to the clamping ring 10 by means of four screws 41, 42, 43, 44. For this purpose, each of the screws 41 . . . 44 runs through a passage opening 13a, 13b, 14a, 14b in the clamping ring 10, while the threads of the screws 41 . . . 4 interact with the internal threads in the central openings 24a, 25a; 34a, 35a of the fastening pins 24, 25; 34, 35. The heads of the screws 41 . . . 44 are received in the sections of larger diameter of the passage openings 13a, 13b, 14a, 14b (see also FIG. 4). The upper mouths of the guide cylinders 22, 23; 32, 33 are aligned with the sector-like recesses 11, 12 in the clamping ring 10.

First ends of four hoses 51, 52, 53, 54 are received in the guide cylinders 22, 23; 32, 33 of the guide parts 20, 30, see also FIG. 3. The hoses 51, 52, 53, 54 are glass-fibre hoses with silicone sheathing. The hoses 51, 52, 53, 54 are fastened in the guide cylinders 22, 23; 32, 33 with the aid of metallic hollow-cylindrical inserts 55, 56, 57, 58. For this purpose, the hoses 51 . . . 54 are first pulled through the guide cylinders 22, 23; 32, 33, and the inserts 55 . . . 58 are inserted into the hoses 51 . . . 54. The hoses 51 . . . 54 with inserts 55 . . . 58 received therein are then pushed back until a collar 57a, 58a of the respective insert 55 . . . 58 rests on the end face of the corresponding guide cylinder 22, 23; 32, 33. In this case, the hose is clamped between the inner face of the guide cylinder 22, 23; 32, 33 and the insert 55 . . . 58 and is thus secured.

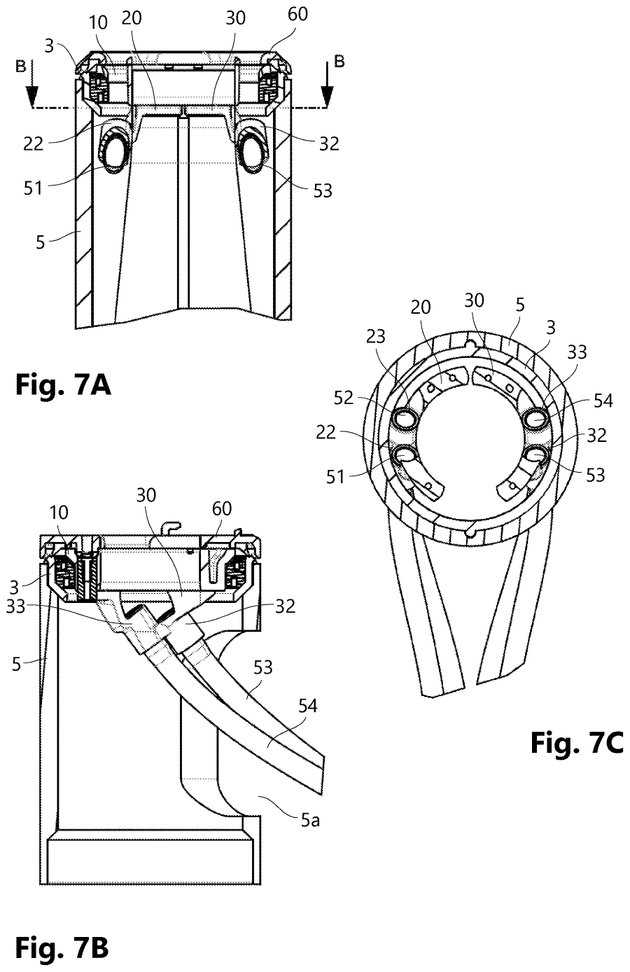

FIG. 4 is an isometric view of the introduction device arranged on a fork. FIG. 5 shows a side view of the fork 2, the head tube 5 and the introduction device, and FIG. 6 shows a plan view of the fork 2 with the introduction device mounted. FIG. 7A shows a first vertical section through the head tube with the introduction device mounted in the plane A-A (cf. FIG. 6). FIG. 7B shows a second vertical section through the head tube with the introduction device mounted in the plane C-C (cf. FIG. 6). FIG. 7C shows a horizontal section through the head tube and the introduction device in the plane B-B (cf. FIG. 7A).

The clamping ring 10 sits on the upper bearing 3 of the headset. The hoses 51, 52, 53, 54 arranged on the clamping ring 10 via the guide cylinders 22, 23; 32, 33 of the guide parts 20, 30 are guided around the fork shaft 2a and extend substantially downwards along the latter. They can therefore be received together by the head tube 5 and guided through a lateral opening 5a out of the head tube 5 into a further frame tube, for example the down tube.

The head tube 5 is closed off at the top by a cover 60 made of plastic. For this purpose, the cover 60 has, on its underside, clip elements which interact with the recesses 14d, 14e and passage openings 14f, 14g in the clamping ring 10. The cover 60 has two arcuate slots 61, 62 which are aligned with the recesses 11, 12 in the clamping ring 10. The cables are guided through these slots 61, 62 and the recesses 11, 12 into the guide parts 20, 30 and therefore into the hoses 51, 52, 53, 54 running in the frame.

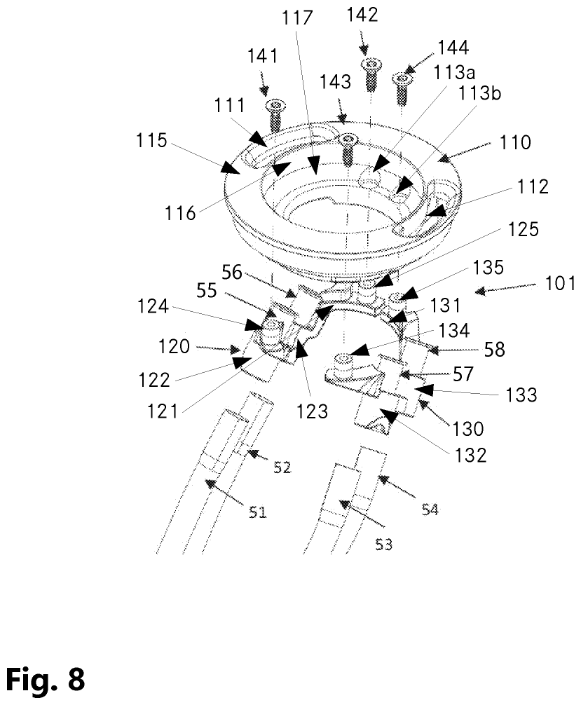

FIG. 8 is an exploded view of a second embodiment of an introduction device according to the invention with hoses arranged thereon for receiving cables.

The introduction device 101 comprises a holding ring 110 and two guide parts 120, 130 fastened thereto.

The holding ring 110 has substantially the shape of a circular ring. This can be pressed into the upper open end of a head tube, so that it is held in a rotationally fixed manner in the head tube. The holding ring 110 comprises an upper flange 115, a cylindrical section 116 which adjoins the flange 115 on the inside, and a lower flange 117 which extends inwards at the lower end of the cylindrical section 116. The lower flange 117 defines a central through-opening and it has a geometry which enables the fork shaft to be received with the corresponding bearing elements. Two annular through-openings 111, 112 with an angle of in each case approximately 45° are present in the upper flange 115.

The two guide parts 120, 130 are manufactured from polyamide and are configured mirror-symmetrically with respect to one another. Their geometry corresponds largely to that of the guide parts of the first embodiment, which has been described in more detail further above in conjunction with FIG. 2. Each of the guide parts 120, 130 has an annular frame 121, 131. In each case two guide cylinders 122, 123; 132, 133 are formed in one piece on the latter. Likewise, fastening pins 124, 125; 134, 135 are formed in one piece in each case at the ends of the frames 121, 131. They have a cylindrical shape and have a central opening with an internal thread. The central axes of the guide cylinders 122, 123 of the first guide part and the central axes of the guide cylinders 132, 133 of the second guide part are in each case parallel to one another. In addition, they have an angle of approximately 35° with respect to the central axes of the central openings in the fastening pins 124, 125; 134, 135, which are all parallel to each other.

The guide parts 120, 130 are screwed to the holding ring 110 by means of four screws 141, 142, 143, 144. For this purpose, each of the screws 141 . . . 144 runs through a passage opening 113a, 113b in the lower flange 117 of the holding ring 110, while the threads of the screws 141 . . . 144 interact with the internal threads in the central openings of the fastening pins 124, 125; 134, 135. The heads of the screws 141 . . . 144 are received in the sections of larger diameter of the passage openings 113a, 113b. The upper mouths of the guide cylinders 122, 123; 132, 133 are aligned with the annular through-openings 111, 112 in the holding ring 110.

First ends of four hoses 51, 52, 53, 54 are received in the guide cylinders 122, 123; 132, 133 of the guide parts 120, 130. The hoses 51, 52, 53, 54 are glass-fibre hoses with silicone sheathing. The hoses 51, 52, 53, 54 are fastened in the guide cylinders 122, 123; 132, 133 analogously to the first embodiment with the aid of metallic hollow-cylindrical inserts 55, 56, 57, 58. For this purpose, the hoses 51 . . . 54 are first pulled through the guide cylinders 122, 123; 132, 133, and the inserts 55 . . . 58 are inserted into the hoses 51 . . . 54. The hoses 51 . . . 54 with inserts 55 . . . 58 received therein are then pushed back until a collar of the respective insert 55 . . . 58 rests on the end face of the corresponding guide cylinder 122, 123; 132, 133. In this case, the hose is clamped between the inner face of the guide cylinder 122, 123; 132, 133 and the insert 55 . . . 58 and is thus secured.

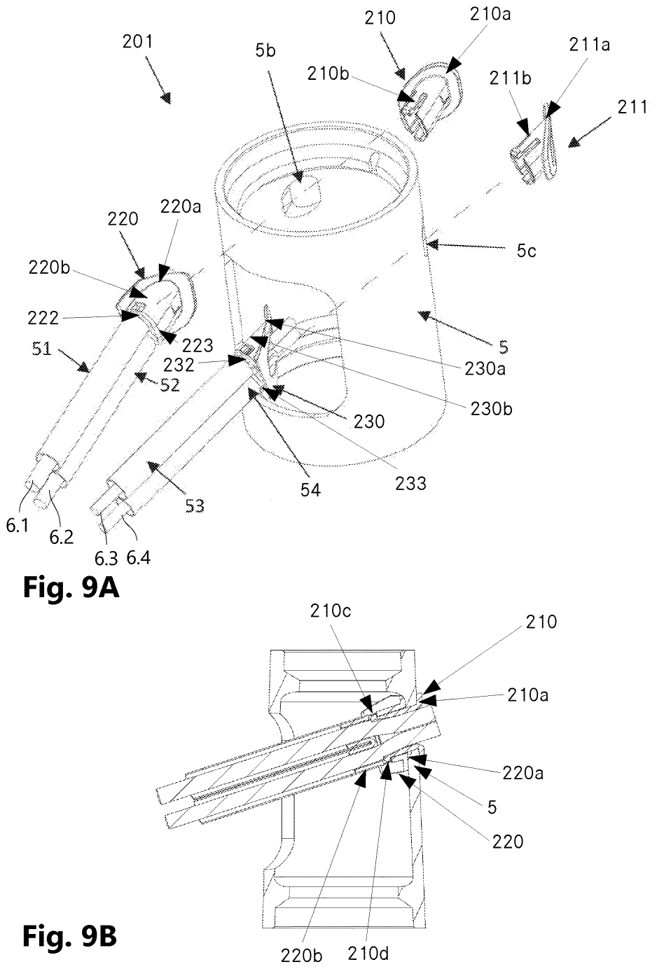

FIG. 9A is an exploded view of a third embodiment of an introduction device according to the invention with hoses arranged thereon for receiving cables. FIG. 9B is a cross-sectional view of the introduction device according to the third embodiment received in a head tube.

This introduction device 201 serves to introduce cables into the head tube, through two lateral openings 5b, 5c in the head tube 5. It comprises one holding part 210, 211 per opening 5b, 5c. This comprises a collar 210a, 211a and a prismatic insert part 210b, 211b. The prismatic insert part 210b, 211b can be inserted in a matching manner into the corresponding opening 5b, 5c of the head tube 5, until the collar 210a, 211a rests on the outer surface of the head tube 5. By means of a clip connection, a guide part 220, 230 can then be fastened to the corresponding prismatic insert part 210b, 211b of the holding part 210, 211. For this purpose, the prismatic insert part 210b, 211b has, at its free end opposite the collar 210a, 211a, outwardly directed latching lugs 210c, 210d. The guide parts 220, 230 likewise have a collar 220a, 230a and a prismatic main part 220b, 230b. The latching lugs 210c, 210d engage in recesses in the main part 220b, 230b of the guide parts 220, 230 and therefore lock the latter to the holding parts 210, 211. The wall of the head tube 5 is received in a matching manner between the collar 210a, 211a of the holding part 210, 211 and the collar 220a, 230a of the guide part 220, 230.

Each of the guide parts 220, 230 defines two guide cylinders 222, 223; 232, 233. First ends of four hoses 51, 52, 53, 54 are received therein. The hoses 51, 52, 53, 54 are glass-fibre hoses with silicone sheathing. The hoses 51, 52, 53, 54 are fastened in the guide cylinders 222, 223; 232, 233 in the same manner as in the embodiments described above, i.e. with the aid of metallic hollow-cylindrical inserts, wherein the hose 51, 52, 53, 54 is clamped between the inner face of the guide cylinder 222, 223; 232, 233 and the insert and is thus secured.

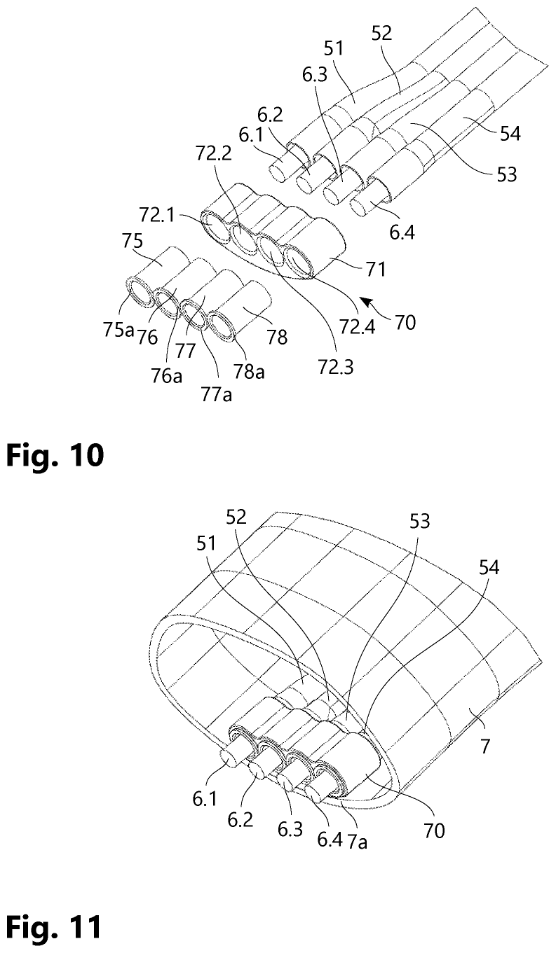

FIG. 10 is an exploded view of a connecting part according to the invention for arrangement in a down tube. FIG. 11 is a view of the connecting part arranged in the down tube.

The connecting part 70 comprises a base part 71 and four hollow-cylindrical inserts 75, 76, 77, 78. The base part 71 has a basic body with four cylindrical receptacles 72.1, 72.2, 72.3, 72.4 which are arranged in a row. The hoses 51, 52, 53, 54 guided through the frame, in particular the down tube, with the cables 6.1, 6.2, 6.3, 6.4 guided therein can be fastened in the cylindrical receptacles 72.1, 72.2, 72.3, 72.4. For this purpose, the hoses 51 . . . 54 are first pulled through the receptacles 71.2 . . . 4, and the inserts 75 . . . 78 are inserted into the hoses 51 . . . 54. The hoses 51 . . . 54 with inserts 75 . . . 78 received therein are then pushed back until a collar 75a, 76a, 77a, 78a of the respective insert 75 . . . 78 rests on the end face of the base part 71. In this case, the hose is clamped between the inner face of the respective receptacle 72.1 . . . 4 and the insert 75 . . . 78 and is thus secured.

In the exemplary embodiment shown, the connecting part 70 is fastened in the region of the rear end of the down tube 7 to its lower wall 7a, for example by adhesive bonding. It positions the hoses 51 . . . 54 there and therefore the cables 6.1 . . . 4 guided therein. The connecting part is accessible in particular through a frame opening there, for example through access to a damper for the rear frame.

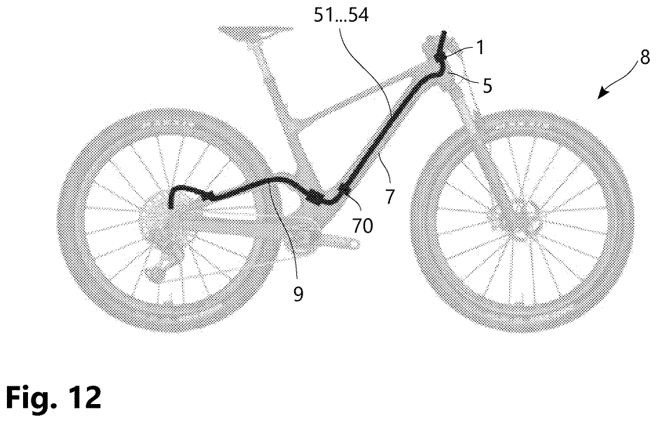

FIG. 12 is a schematic view of the assembly of the device according to the invention in the frame of a bicycle 8. The introduction device 1 is arranged at the upper end of the head tube 5. It fixes four hoses 51 . . . 54 at one end, while their opposite ends are fixed on the connecting part 70 at the lower end of the down tube 7. At least one of the cables is guided within the frame by the connecting part 70 into a fixed sleeve 9 which leads to an outlet opening in the region of the rear axle. The cables can then interact in this region with components to be controlled, for example a shifting mechanism.

The invention is not restricted to the exemplary embodiments shown. In particular, the geometry and arrangement of the elements on the introduction device can be varied in many ways. As mentioned above, the connecting part can be integrated, for example moulded, directly into the frame tube at the rear or lower end of the further frame tube.

In summary, it should be noted that the invention provides a device for guiding at least one cable in a frame of a bicycle which avoids disadvantages of the state of the art.

### REFERENCE NUMERAL LIST

1 Introduction device
2 Fork
2a Fork shaft
3 Bearing
5 Head tube
5a Opening
5b, 5c Opening
6.1 . . . 4 cable
7 down tube
7a wall
8 bicycle
9 sleeve
10 clamping ring
11 recess
12 recess
13 segment
13a,b passage opening
14 segment
14a,b passage opening
14c slot
14d,e recess
14f,g passage opening
20 guide part
21 frame
22 guide cylinder
23 guide cylinder
24 fastening pin
24a opening
25 fastening pin
25a opening
30 guide part
31 frame
32 guide cylinder
33 guide cylinder
34 fastening pin
34a opening
35 fastening pin
35a opening
41 screw
42 screw
43 screw
44 screw
51 hose
52 hose
53 hose
54 hose
55 insert
56 insert
57 insert
57a collar
58 insert
58a collar
60 cover
61 slot
62 slot
70 connecting part
71 base part
72.1 . . . 4 receptacle
75 insert
75a collar
76 insert
76a collar
77 insert
77 collar
78 insert
78a collar
101 Introduction device
110 holding ring
111 passage opening
112 passage opening
113a, 113b passage opening
115 flange
116 section
117 flange
120 guide part
121 frame
122 guide cylinder
123 guide cylinder
124 fastening pin
125 fastening pin
130 guide part
131 frame
132 guide cylinder
133 guide cylinder
134 fastening pin
135 fastening pin
141 screw
142 screw
143 screw
144 screw
201 Introduction device
210 Holding part
210a collar
210b insert part
210c latching lug
210d latching lug
211 holding part
211a collar
211b insert part
220 guide part
220a collar
220b main part
222 guide cylinder
223 guide cylinder
230 guide part
230a collar
230b main part
232 guide cylinder
233 guide cylinder

1. A device for guiding at least one cable in a frame of a bicycle, comprising:
an introduction device, configured to be attached to a first tube of the frame, for introducing the at least one cable into the first tube; and
at least one hose for receiving the cable;
wherein the at least one hose is arranged with a first end on the introduction device and is configured to be received in the first tube and at least one further frame tube.

2. The device of claim 1, wherein the first tube is a head tube of the bicycle, and wherein the introduction device comprises an annular element for arrangement in the head tube,
wherein the annular element has at least one opening for guiding the cable into the head tube, and
wherein a rigid guide part is arranged on the annular element,
wherein the first end of the hose is arranged on the inside of the head tube on the guide part in such a way that the cable is configured to be guided through the opening into the hose.

3. The device of claim 2, wherein the annular element is a clamping ring of a headset.

4. The device of claim 2, wherein the annular element is configured to be received in a press fit in the head tube.

5. The device of claim 2, wherein the at least one opening is formed by an arcuate recess on an outer edge of the annular element.

6. The device of claim 2, wherein the guide part is configured in such a way that, in a region of the first end, a center axis of the hose runs at an angle to a central axis of symmetry of the annular element.

7. The device of claim 2, wherein the guide part is configured to be removably fastened to the annular element.

8. The device of claim 2, wherein the guide part is configured in such a way that at least two hoses are fastenable to the guide part.

9. The device of claim 2, wherein at least two guide parts are configured to be attached in a modular manner to the annular element.

10. The device of claim 1, wherein the introduction device comprises a holding element for arrangement in a lateral opening in the first tube,
wherein the holding element has at least one opening for guiding the cable into the first tube, and
wherein a rigid guide part is arranged on the holding element,
wherein the first end of the hose is arranged on the inside of the first tube on the guide part in such a way that the cable is configured to be guided through the opening into the hose.

11. The device of claim 10, wherein the guide part is configured to be removably fastened to the holding element.

12. The device of claim 10, wherein the guide part is configured in such a way that at least two hoses are fastenable to the guide part.

13. The device of claim 2, wherein in order to fasten the hose to the guide part, a hollow-cylindrical insert is configured to be inserted into a region at the first end of the hose, after which the first end of the hose with inserted insert is insertable into a hollow-cylindrical receptacle of the guide part, so that the hose is clamped in the receptacle.

14. The device of claim 13, wherein the insert has, at one of ends thereof, a radially outwardly directed collar for support on the guide part.

15. The device of claim 1, comprising a connecting part for arrangement in the at least one further frame tube, wherein the connecting part is configured in such a way that at least one hose is arrangeable with a second end on the connecting part.

16. The device of claim 1, wherein the at least one hose is a glass-fibre hose with silicone sheathing.

17. A frame for a bicycle having a device for guiding cables according to claim 1.

18. The frame of claim 17, having a device for guiding cables comprising a connecting part for arrangement in the further frame tube, wherein the connecting part is moulded directly into the at least one further frame tube.

19. The frame of claim 17, having a device for guiding cables comprising a connecting part for arrangement in the at least one further frame tube, wherein the connecting part is arranged in the region of a frame opening.

20. The device of claim 12, wherein the holding element is configured in such a way that the at least two hoses are guidable through the same opening of the holding element.

21. The device of claim 8, wherein the annular element is configured in such a way that the at least two hoses are guidable through the same opening of the annular element.
